(19) United States
(12) Patent Application Publication
(10) Pub. No.: US 2021/0067696 A1
(43) Pub. Date: Mar. 4, 2021

(54) CAMERA SYSTEM INCLUDING A LENS FOR PIXEL REMAPPING

(71) Applicant: EMBEDTEK, LLC, Waukesha, WI (US)

(72) Inventor: Kent Tabor, Pewaukee, WI (US)

(21) Appl. No.: 17/008,273

(22) Filed: Aug. 31, 2020

Related U.S. Application Data
(60) Provisional application No. 62/894,468, filed on Aug. 30, 2019.
(60) Provisional application No. 62/897,975, filed on Sep. 9, 2019.

(51) Int. Cl. H04N 5/232

(52) U.S. Cl. CPC H04N 5/23235; H04N 5/232125; H04N 5/232127

(57) ABSTRACT

A system for capturing an image includes a camera positioned relative to an area, a camera sensor having an X-Y plane and an aspect ratio defined by a quantity of pixels in the X-Y plane, and a lens constructed with a profile to optically capture a desired zone of the area. The lens remaps pixels associated with the area outside the desired zone to within the desired zone to form a desired pixel distribution within a captured image of the desired zone.

### RELATED APPLICATIONS

The present application claims priority to U.S. Provisional Application 62/894,468, filed Aug. 30, 2019, and U.S. Provisional Application 62/897,975, filed Sep. 9, 2019, the entire contents of which are hereby incorporated by reference.

### BACKGROUND

The present invention relates generally to imaging, and, more specifically, a non-linear lens constructed to optically remap pixels of an image sensor from an area outside the desired zone to within the desired zone to form a desired pixel distribution within a captured image of the desired zone.

Many cameras include X-Y aspect ratios that describe the relationship between the width (X) and the height (Y) of the image. The aspect ratios have a specific resolution with a uniform distribution of pixels that describes the relationship between the width of the pixel compared to the height of the pixel. Typically, a camera sensor has a uniform pixel distribution and an aspect ratio that is defined by the total number of pixels in the X-Y plane for the camera sensor. The lens distributes the incident light to the pixels of the camera sensor to capture an image, and a processor processes the captured image to form an image that has a field of view with an aspect ratio (e.g., 4:3 standard, 16:9 standard, etc.). The field of view typically encompasses or includes all of the area in front of the camera, with objects closer to the camera appearing larger than objects farther from the camera. The depth of field of existing cameras defines the area of the field of view that appear in focus.

To increase the resolution of an image, the number of pixels or pixel density of a camera sensor increases, which increases the cost to manufacture the camera. In some applications, such as surveillance cameras, a relatively small portion of the image is considered an area of interest or the desired field of view. Therefore, sensors with a uniform distribution of pixels may be unable to provide the desired resolution within the area of interest and, at the same time, many pixels that are processed are not useful for identifying objects that are outside the area of interest.

FIGS. 1 and 2 illustrate an image 24 taken by an existing camera with objects that are in close proximity to and far away from to the camera (referred to and represented as shallow area 42, deep area 46, with a middle area 50 between areas 42, 46). The image 24 captured by the camera has a field of view that includes objects (e.g., vehicle 58) that are fairly clearly visible in the shallow area 42, and objects (e.g., vehicle 62) that are blurred and obscured from clear view. The field of view in this example includes a continuous section of roadway 32 (e.g., taken by a tollbooth camera), as well as areas around the roadway 32.

Existing cameras typically cannot optically separate out or only focus on the desired area 30 outlined by the frame 38 (e.g., the roadway) and eliminate or disregard the undesired area(s) 34 (e.g., the tree line on each side of the roadway 32, as well as the skyline). Some cameras may use motion detection algorithms to block out portions of the image 24 from being monitored. Also, the uniform pixel distribution of the camera causes the objects that are positioned relatively close to the camera, inside and outside the frame 38, to appear with a higher resolution than is necessary to view objects in those areas. At the same time, objects relatively far from the camera appear with a lower resolution than is necessary to adequately view relevant objects.

The image 24, which is taken by positioning the existing camera relative to the roadway to monitor vehicles on the roadway 32 for identification of specific vehicles via their respective license plate(s), does not adequately identify the vehicle 58 and the vehicle 62 in the same image 24. This is shown in the schematic illustration of FIG. 2, where the license plate 66 of the vehicle 58 is easily readable on the image 24, but the license plate 70 of the vehicle 62 cannot be read or discerned (e.g., illustrated in FIG. 2 as letters “FGHIJ” and “ABCDE”, respectively). In this example, existing camera technology produces an image with the license plate 66 that is larger and with a higher resolution than is necessary to identify the first vehicle 58, and with the license plate 70 that is smaller and with a lower resolution than is necessary to identify the second vehicle 62. The vertical scale of the image 24 is not linear, so the second vehicle 62 and the second license plate 70 appear much smaller than the first vehicle 58 and the first license plate 66.

### SUMMARY

In one aspect, the disclosure provides a system for capturing an image includes a camera positioned relative to an area, a camera sensor having an X-Y plane and an aspect ratio defined by a quantity of pixels in the X-Y plane, and a lens constructed with a profile to optically capture a desired zone of the area. The lens remaps pixels associated with the area outside the desired zone to within the desired zone to form a desired pixel distribution within a captured image of the desired zone.

In another aspect, a method for capturing an image includes positioning a camera relative to an area, wherein the camera comprises a camera sensor having an X-Y plane and an aspect ratio defined by a quantity of pixels in the X-Y plane, and a lens constructed with a profile to optically capture a desired zone of the area. An image is captured using the camera sensor. The lens remaps pixels associated with the area outside the desired zone to within the desired zone to form a desired pixel distribution within the captured image of the desired zone.

### BRIEF DESCRIPTION OF THE DRAWINGS

FIG. 1 is an image taken by existing camera technology.

FIG. 2 is a schematic view of the image of FIG. 1.

FIG. 3 is a schematic view of an exemplary camera system of the present invention and including a camera having a lens and a sensor that optionally communicates with a processor.

FIG. 4 is a schematic view illustrating a process of optically capturing a desired zone of an area through the lens of the camera system of FIG. 3 to define an adjusted image.

FIGS. 5A and 5B illustrate an exemplary area that is optically captured by the camera system of FIG. 3 to define an adjusted image of a portion of the area.

FIG. 5C is a schematic view illustrating a process of redirecting the pixels of the image sensor into a desired zone of a three-dimensional area using the reflector of the imaging system of FIG. 3 to define an altered frame.

FIG. 5D is a schematic view illustrating a process of capturing the altered frame with the imaging system of FIG. 3 to define an adjusted image.

FIG. 6 is a schematic view of another exemplary camera system including a camera having a lens and a sensor that optionally communicates with a processor.

FIG. 7 is a schematic view illustrating a process of optically capturing a desired intersection having separate zones in an exemplary area through a non-linear lens of a camera system to define an adjusted image of the zones.

FIG. 8 is a schematic view of another exemplary camera system including a camera having a lens and a sensor that optionally communicates with a processor.

FIG. 9 is a schematic view illustrating a process of optically capturing a desired front zone and desired peripheral zones of an exemplary area through a non-linear lens of a camera system to define an adjusted image of the zones.

Before any embodiments of the present invention are explained in detail, it should be understood that the invention is not limited in its application to the details or construction and the arrangement of components as set forth in the following description or as illustrated in the drawings. The invention is capable of other embodiments and of being practiced or of being carried out in various ways. It should be understood that the description of specific embodiments is not intended to limit the disclosure from covering all modifications, equivalents, and alternatives falling within the spirit and scope of the disclosure. Also, it is to be understood that the phraseology and terminology used herein is for the purpose of description and should not be regarded as limiting.

### DETAILED DESCRIPTION

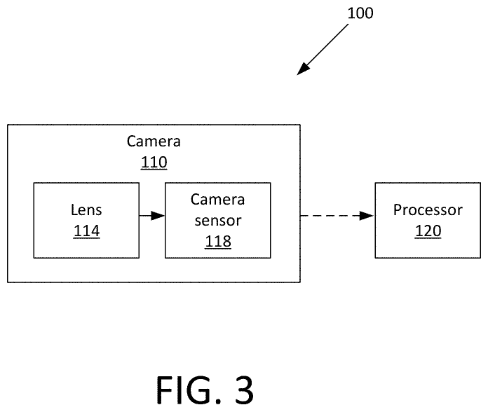

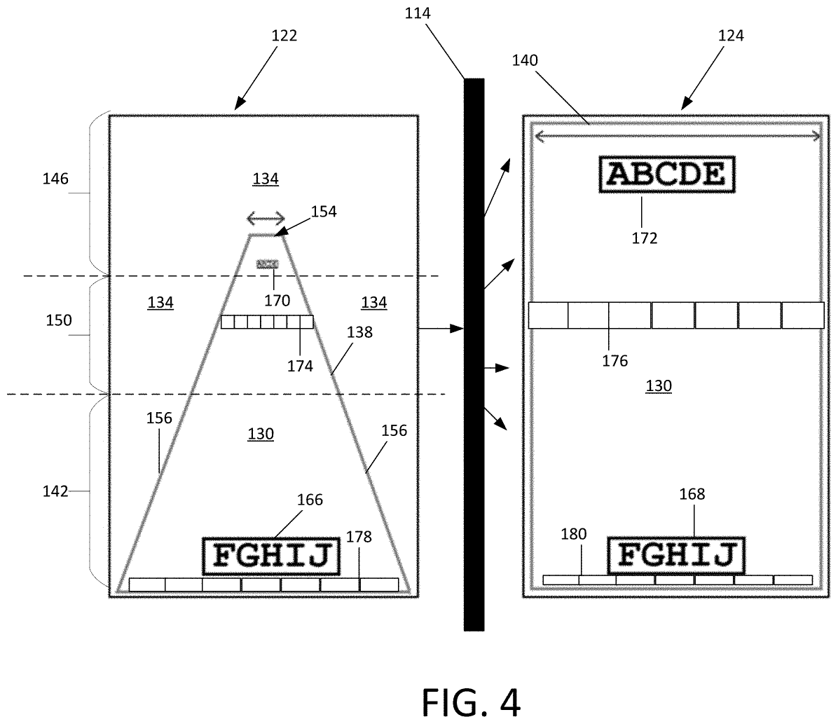

FIGS. 3 and 4 illustrate a system 100 of the present invention that has a camera 110, a non-linear or progressive lens 114 (referred to as a ‘non-linear lens’ for purposes of description), and a camera sensor 118 (e.g., one sensor 118 or more than one sensor 118). The lens 114 is constructed to have a unique profile (e.g., contour, shape, and/or size) to optically capture an area of interest or desired zone 130 (e.g., defined by a frame 138) in an area 122 that the camera 110 is positioned relative to. In some embodiments, the non-linear lens 114 optically captures a continuous portion or segmented (non-continuous) portions of the area 122 that define the desired zone 130. The lens 114 optically capturing the desired zone 130 of the area 122 may include or encompass capturing a part of the area 122, or the entire area 122. In other words, the desired zone 130 may be a small portion of the overall area 122 or the entirety of the area 122.

The non-linear lens may use non-linear optics to optically capture a distorted image of the desired area 130. For example, the non-linear lens 114 may be a non-spherical type lens that is manufactured with optical clarity via 3D printing or other technology that is suitable for shaping the lens 114 for the application the system 100 will be applied to. The lens 114 may be constructed of one or more elements that cooperatively define the non-linear nature of the lens 114. For example, the lens 114 may be constructed of any combination of elements that are optically clear, reflective, optically liquid materials (e.g., to form a liquid lens), or include microelectromechanical systems (MEMS). The unique profile of the non-linear lens 114 is designed for each specific application (e.g., monitoring a roadway at a tollbooth, monitoring a storage facility, an intersection, etc.) to remap or redistribute the pixels within the desired zone(s) 130 to form a desired pixel distribution within the desired zone 130 without wasting pixels on undesired zone(s) 134 outside of a frame 138 (see FIG. 4). For example, the desired pixel distribution may include a unified pixel density or an uneven pixel distribution within the desired zone(s) 130 depending on the application of the camera 110 and the desired output image. The profile of the non-linear lens 114 may be constructed to take into account the shape or profile of the desired zone(s) 130 (e.g., width, distance, segmented portions) and the height of the camera 110 relative to the area 122 that is being monitored. The mapping done by the lens 114 may be fixed, or the mapping may be done using MEMS technology to dynamically change elements of the lens 114 and, as a result, how the desired zone(s) 130 are captured by the lens 114 (e.g., by changing the pixels direction electronically).

After the unique profile of the non-linear lens 114 is constructed for the specific application, the non-linear lens 114 is positioned relative to an area 122 (FIG. 4) to focus the desired zone 130 in the area 122 across a pixelated area of the camera sensor 118. The lens 114 may include an aperture that controls the amount of light that enters the lens 114. The non-linear lens 114 may adjust the focal point of each pixel in the desired zone(s) 130 without changing the amount of light that enters the lens 114 (e.g., without changing the size of the aperture; without zooming in or out), which increases the clarity and depth of field of the captured desired zone 130. The non-linear lens 114 expands the pixels of the captured desired zone 130 to match or fill the entire aspect ratio of the camera sensor 118 so the entire aspect ratio of the camera sensor 118 is utilized only to capture the desired zone 130 (and objects in the zone 130). The system 100 may include a processor 120 (e.g., a microprocessor, a processing chip, Field Programmable Gate Arrays (FPGAs), etc.) that is integral with or separate from the camera 110 to process the desired zone(s) 130. As shown in FIG. 4, the processor 120 processes the pixels on the camera sensor 118 to store and analyze an enhanced or adjusted image 124. For example, the modified image 124 can be stored using cloud based storage, and analyzed using imaging software such as Optical Character Recognition (“OCR”) or other imaging software. Additionally, the processor 120 may dynamically change the one or more elements of the lens 114 to adjust the pixel directions and/or the desired zone(s) captured by the lens 114.

FIG. 4 illustrates an exemplary embodiment of the adjusted image 124 captured through the non-linear lens 114. The non-linear lens 114 is constructed to capture the adjusted image 124 with a unified pixel distribution in the desired zone 130 of the area 122, while the undesired zone 134 positioned outside the frame 138 is not captured (i.e. the undesired zone 134 is not transferred to the camera 110). More specifically, the non-linear lens 114 may produce the same pixels per square foot in an area relatively far from the camera 110 as in an area relatively close to the camera 110. The non-linear lens 114 has a unique profile that expands (e.g., vertically, horizontally, or both vertically and horizontally) the frame 138 and consequently the pixels that are positioned within the frame 138 to define an adjusted frame 140 that matches or fills the aspect ratio of the camera sensor 118 (see FIG. 4).

In some constructions, the non-linear lens 114 may arrange the pixels within the desired frame 138 in a plurality of rows that increases in pixel density as the desired zone 130 extends farther from the camera 110. For example, the desired frame 138 may include a first row of pixels 174 and a second row of pixels 178, each of which is positioned within the desired zone 130 of the area 122, but not necessarily in close proximity with each other. The non-linear lens 114 arranges the pixels such that the first row of pixels 174 has the same, or nearly the same, pixels per square foot as the second row of pixels 178. As a result, the first row of pixels 174 positioned relatively far from the camera 110 are expanded to form an adjusted first row of pixels 176 in the adjusted frame 140. At the same time, the second row of pixels 178 may be relatively unchanged (e.g., remain the same size, or slightly reduced in size) after passing through the non-linear lens 114, or the pixels 178 may be adjusted to form an adjusted second row of pixels 180. Additionally, the pixels positioned beyond the second row of pixels 178 proximate to an end 154 of the frame 138 and the pixels positioned between the first and second row of pixels 174, 178 may be adjusted in the same manner by the lens 114. As a result, the objects in close proximity to and far away from the camera 110 and the lens 114 have relative clarity in the same image 124.

Expansion of the frame 138 to match the aspect ratio of the camera sensor 118 spreads the pixels of the desired zone 130 to produce the adjusted image 124 that represents a slightly distorted view of the zone 130. As a result, the size of the objects positioned relatively far from the camera 110 are adjusted to be the same size or approximately the same size as the objects positioned relatively close to the camera 110. Because the frame 138 has a unified pixel density with a greater pixel density relatively far from the camera 110 when compared to relatively close to the camera, the adjusted image 124 has a uniform final resolution.

In one example, after the pixels receive light passed through the non-linear lens 114, the pixels may be orientated in the wrong direction or distorted. As a result, the processor 120 may determine the correct positioning of the pixels to produce the final image for the processing system or a user. In some constructions, the system 100 may redistribute the pixels within the adjusted image 124 to further increase the resolution in the adjusted image 124 of specific areas of the desired zone 130. In other example, the processor 120 may include imaging software such as OCR or machine vision that processes the pixels on the camera sensor 118 to analyze and store the desired data from the adjusted image 124. In some constructions, the processor 120 may transmit the adjusted image 124 to a display over the communication network (e.g., wired, or wireless such as Bluetooth®, Wi-Fi™, etc.) for use by personnel assigned to monitor the desired zone 130.

The camera 110 may be used to monitor objects (e.g., vehicles, people, people counting, safety, security, etc.) that are in the desired zone 130 of the field of view for many different applications. The desired zone 130 is predetermined determined by the application to which the system will be applied. As a result, the desired zone 130 and the construction of the non-linear lens 114 may vary based on the placement of the camera 110 or the desired zone 130 of the area 122 the camera 110 is monitoring. While the desired zone 130 shown in the drawings is a continuous zone, it will be appreciated that the desired zone may include disjointed or unconnected portions of the area(s) to be monitored.

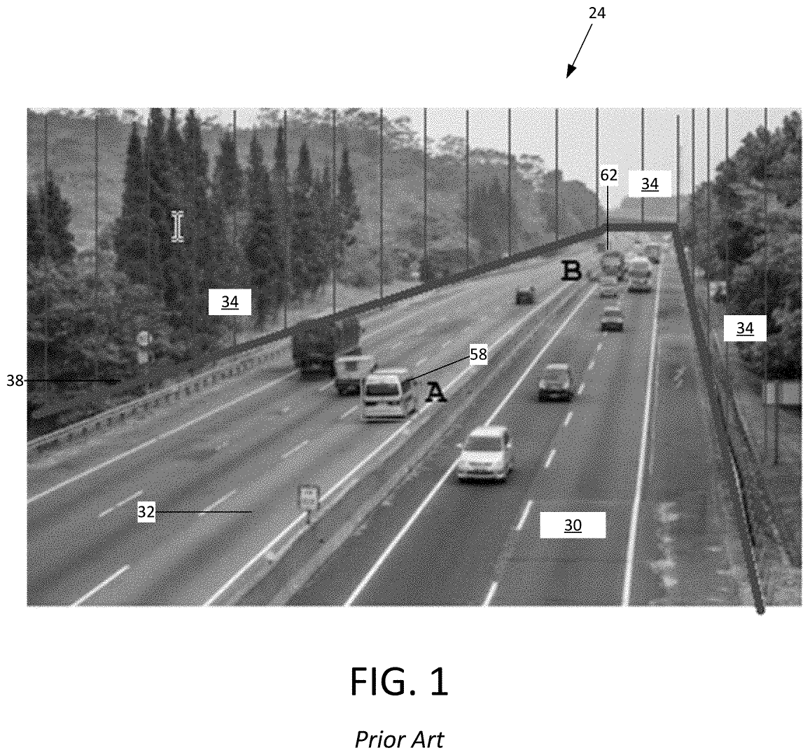

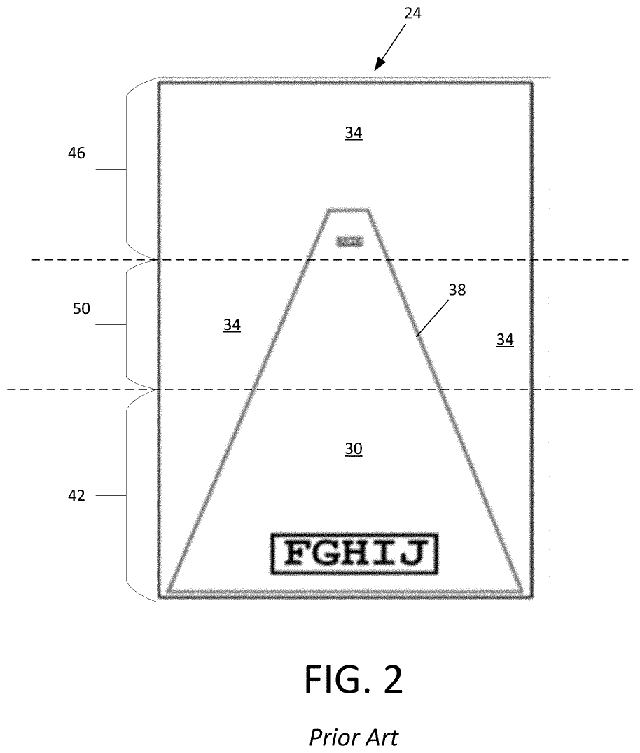

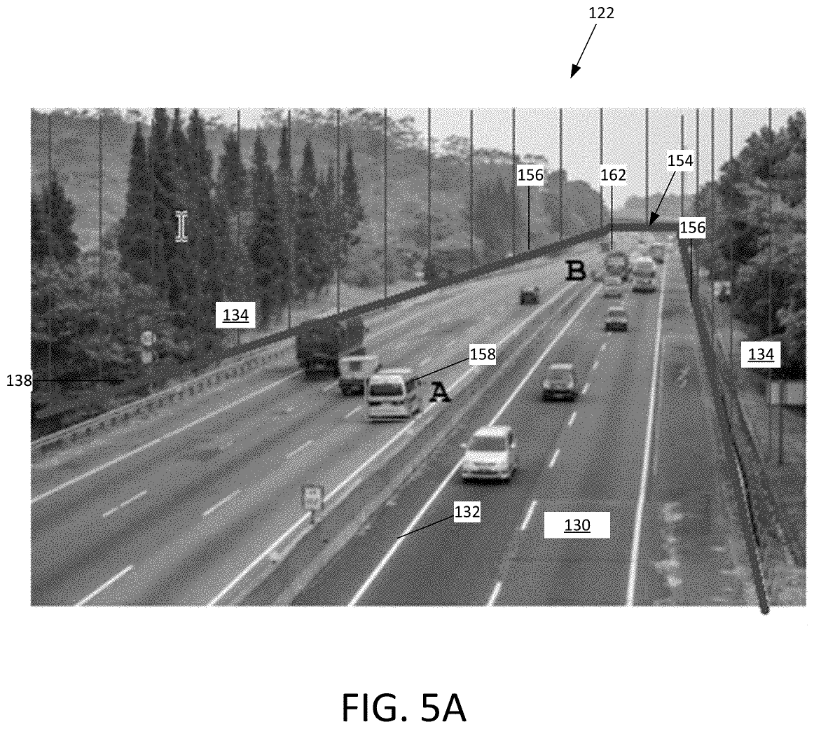

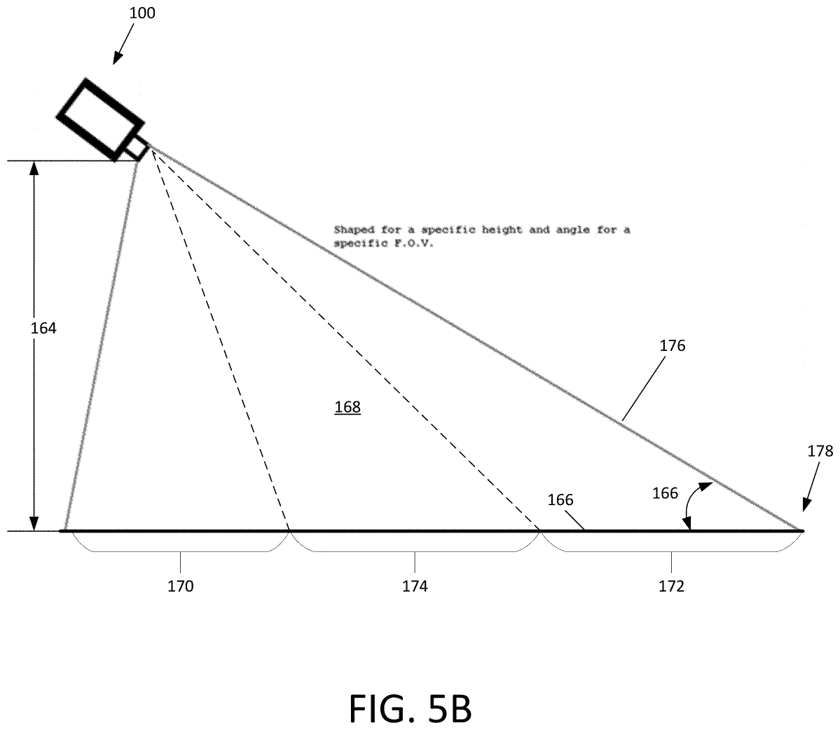

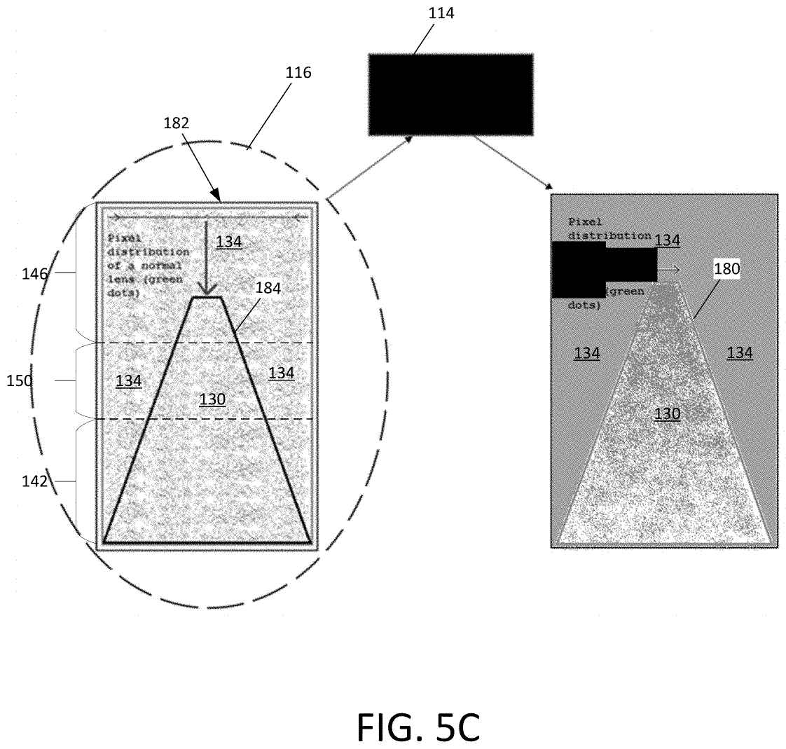

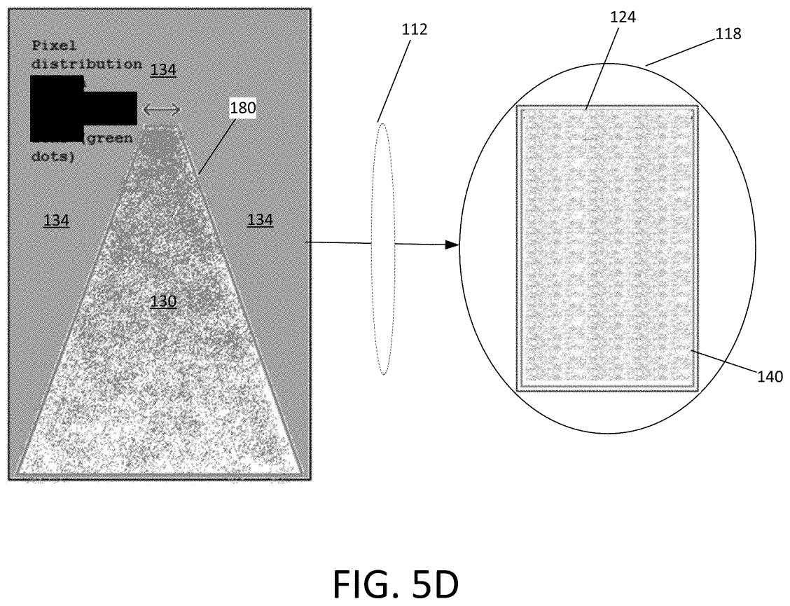

FIG. 5A shows how the system 100 can be applied to the tollbooth/roadway example shown in FIG. 1. With reference to FIG. 5A, the system 100 would only focus on the roadway 132 (i.e. the desired zone 130 in this example). The camera 110 is positioned above an area 122 having the roadway 132 (e.g., at a tollbooth) to monitor vehicles on the roadway 132 to identify specific vehicles via their license plate(s). For example, the illustrated roadway 132 includes a first vehicle 158 relatively near to the camera 110 (e.g., in a shallow area 142 of the field of view illustrated in FIG. 4) and a second vehicle 162 relatively far from the camera 110 (e.g., in the deep area 146 of the field of view illustrated in FIG. 4). The first vehicle 158 includes a first license plate 166 and the second vehicle 162 includes a second license plate 170 (e.g., illustrated in FIG. 4 as letters “FGHIJ” and “ABCDE”, respectively).

The non-linear lens 114 is constructed to optically capture and monitor the roadway 132 without capturing the undesired zone(s) 134 (in this example, the tree lines and skyline). The desired zone 130 is bounded by a frame 138 that includes a continuous section of the roadway 132 with the first vehicle 158 having the first license plate 166 and the second vehicle 162 having the second license plate 170.

After the non-linear lens 114 is constructed and positioned relative to the roadway 132 and the camera 110, the non-linear lens 114 expands the frame 138 (e.g., vertically, horizontally, or both vertically and horizontally) and, consequently, the pixels that are positioned within the frame 138, to define the adjusted image 124 that matches or fills the aspect ratio of the camera sensor 118 (see FIG. 4). In this example, the non-linear lens 114 expands the end 154 of the frame 138 horizontally and vertically, and sides 156 horizontally, to form the adjusted frame 140. Expanding the frame 138 increases the size of the second vehicle 162 and, in turn, the second license plate 170 so that the license plate 170 is the same size or approximately the same size as the first license plate 166. As a result, the first license plate 166 and the second license plate 170, which are in different areas of the area 122, are both visible and readable for monitoring of the vehicles 158, 162. The processor 120 determines and records the letters of the first and second license plate 166, 170 (e.g., using OCR).

While the system 100 is described and illustrated with regard to monitoring vehicles 158, 162 and their respective license plates 166, 170, it will be appreciated that the system can monitor any number of vehicles and/or licenses plates in the desired frame 138. Also, the system is applicable to various applications and should not be construed to apply only to vehicular or roadway monitoring.

FIG. 5B illustrates an exemplary position of the imaging system 100 that has a specific contour for monitoring an area from a specific height 164 above a surface 166, such as the roadway 132 or a floor. The imaging system 100 (and the non-linear lens 114 is positioned at an angle 166 relative to the surface 166, which defines an angular view 168 of the imaging system 100. For example, the imaging system 100 may be a traffic monitoring camera, a surveillance camera (e.g., a camera in a parking structure or at an end of an aisle in a warehouse, etc.). mounted to monitor a desired zone or area within the angular view 168. For example, the desired zone may be the surface 166.

The angular view 168 defines extents of the image that are visible by the imaging system 100. For example, the angular view 168 includes a near area 170, a deep area 172, and a middle area 174 positioned between the near area 170 and the deep area 172. The angular view 168 is bounded by the surface 166 and a set upper limit (e.g., illustrated with line 176) that converges at an angular vantage point 178 in the deep area 172 of the image. The angle 166 of the imaging system 100 and the upper limit 176 of the imaging system 100 may adjusted to encompass a larger or smaller area of the surface 166.

With reference to FIG. 5C, the non-linear lens 114 condenses the pixels such that the portion of an altered frame 180 relatively close to the imaging system 100 has the same, or nearly the same, pixels per square unit area (e.g., inches or feet) as the portions of the altered frame 180 relatively far from the imaging system 100. This is referred to as a desired pixel distribution. The altered frame 180 includes the same number of pixels as the field of view of an area 182 of a conventional lens. Because the altered frame 180 has more pixels than the pixels associated with the conventional frame 184 in the desired area 130, the altered frame 180 has a resolution and a clarity that is higher than the initial resolution of the conventional frame 184. The imaging system 100 captures the altered frame 180 so the pixels are distributed to match the aspect ratio of the camera sensor 118. As a result, the size of the objects positioned relatively far from the imaging system 100 are adjusted to be the same size or approximately the same size as the objects positioned relatively close to the imaging system 100.

In one example, after the pixels pass through the non-linear lens 114 (illustrated by dashed lines), the adjusted image 124 may be orientated in the wrong direction or distorted. As a result, the processor 120 may determine and correct the positioning of the pixels to produce the adjusted image 124 for the user of the processing system. This can include the system 100 redistributing the pixels within the adjusted image 124 to increase the resolution in specific areas of the adjusted image 124. In some constructions, the processor 120 may transmit the adjusted image 124 to a display over a communication network (e.g., wired, or wireless such as Bluetooth®, Wi-Fi™, etc.) for use by personnel assigned to monitor the desired zone 130.

The imaging system 100 may be used to monitor objects (e.g., vehicles, people, people counting, safety, security, etc.) that are in the desired frame 138 of the field of view for many different applications. The desired zone 130 is predetermined by the application to which the system will be applied. As a result, the desired zone 130 and the construction of the non-linear lens 114 may vary based on the placement of the imaging system 100 or the desired zone 130 of the area 122 the imaging system 100 monitors. While the desired zone 130 shown in the drawings is a continuous zone, it will be appreciated that the desired zone for a particular application may include disjointed or unconnected portions of the area(s) to be monitored.

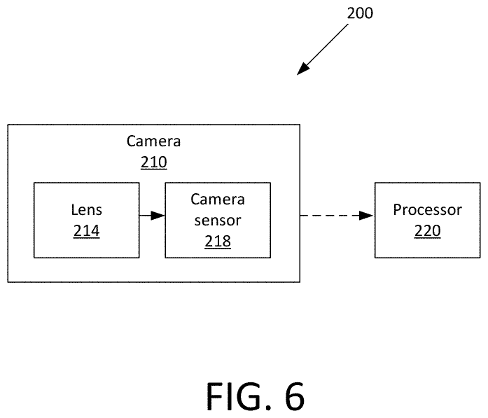

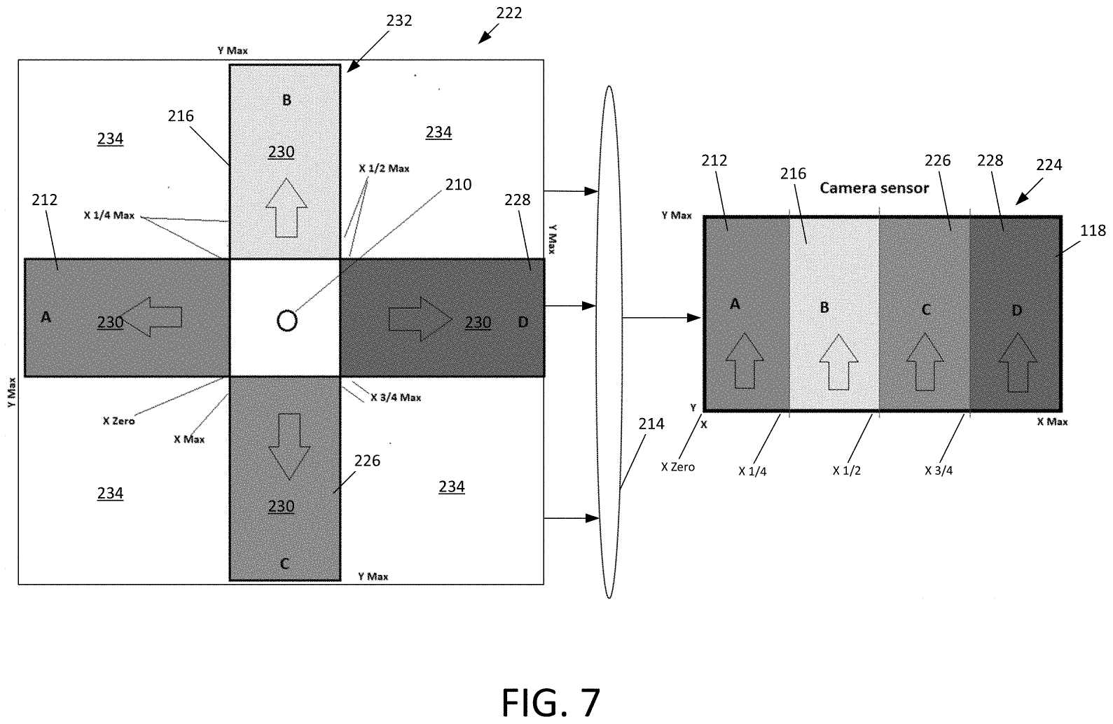

FIGS. 6 and 7 illustrate another exemplary system 200 including a camera 210, a non-linear lens 214 that can be applied to monitor an area 222, and a camera sensor 218. The area 222 is defined by an intersection 232 of different paths or desired zones 230 (e.g., roadways, aisles in a facility, etc.) and undesired zone(s) 234 (e.g., sidewalks, buildings, storage racks, etc.) surrounding the intersection 232. The camera 210 is positioned relative to the area 222 (e.g., at or adjacent a center position of the intersection 232) to monitor objects at or approaching the intersection 232. In the illustrated construction, the intersection 232 includes a first path 212, a second path 216, a third path 226, and a fourth path 228 that intersect to form the T-shaped intersection 232. While FIG. 7 illustrates a four-zone intersection 232, it will be appreciated that the intersection 232 may have any quantity of paths or desired zones (e.g., two, three, four, five, etc.).

The lens 214 optically captures the paths 212, 216, 226, 228 of the intersection 232 (i.e. the desired zones 230 in this example) without wasting pixels on the undesired zone(s) 234 surrounding the intersection 232. The lens 214 may arrange the pixels within the paths 212, 216, 226, 228 so each path 212, 216, 226, 228 has a desired pixel distribution consistent with what is described with regard to FIGS. 3-5. The lens 214 maps the captured paths 212, 216, 226, 228 onto the pixelated area of the camera sensor 218 so that the paths 212, 216, 226, 228 are arranged side by side within the aspect ratio of the camera sensor 218. More specifically, the lens 214 may expand the transposed paths 212, 216, 226, 228 on the camera sensor 218 to define an adjusted image 224 with a linear view of the paths 212, 216, 226, 228 having a uniform resolution. As a result, the objects in each path 212, 216, 226, 228 that are in close proximity to and far away from the camera 210 and the lens 214 have relative clarity in the same image 224.

For example, the lens 214 maps and expands each path 212, 216, 226, 228 on one-quarter of the surface area of the camera sensor 218 so that the paths 212, 216, 226, 228 are positioned in the same orientation relative to each other in the adjusted image 224. In some constructions, a processor 220 may be used to map or rearrange the pixels to achieve the same orientation for the paths 212, 216, 226, 228. Imaging software, such as OCR or machine vision, may be used to analyze the adjusted image 224 to monitor the objects in each path 212, 216, 226, 228.

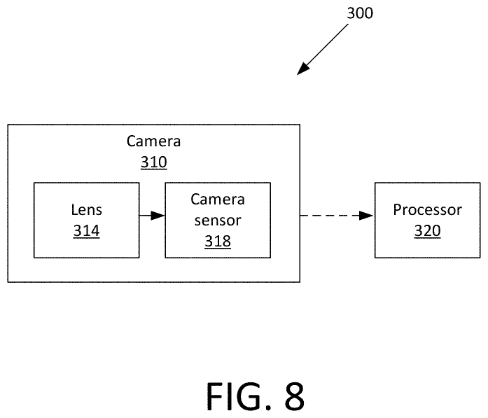

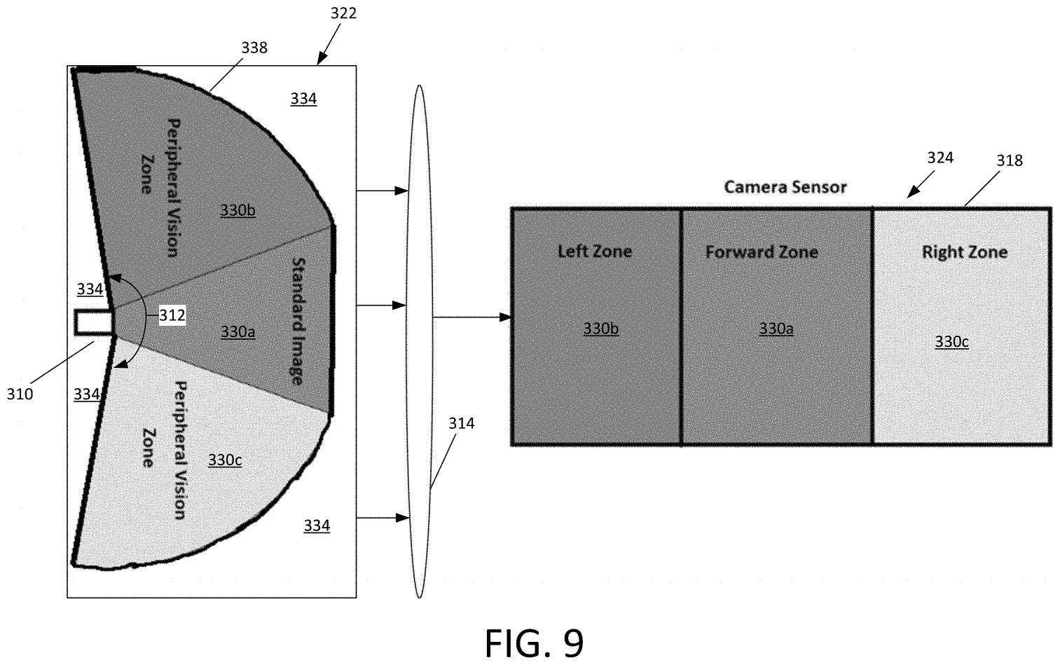

FIGS. 8 and 9 illustrate another exemplary system 300 including a camera 310, a non-linear lens 314 that can be applied to monitor an area 322, and a camera sensor 318. The area 322 is defined by a front desired zone 330a, peripheral desired zones 330b, 330c (relative to the perspective of the camera 310). The illustrated desired zones 330a, 330b, 330c collectively define a sector that is visible to the camera 310. As shown, the camera 310 has a field of view or viewing angle that encompasses portions of the area in front of the camera 310 and slightly behind the camera 310. The viewing angle of the illustrated camera 310 is greater than 180° (e.g., approximately 200°). It will be appreciated that the viewing angle can be less or more than 180° depending on the application of the system 300. The area 322 also may include undesired zone(s) 334 outside of a frame 338 that surrounds the zones 330a, 330b, 330c.

In the illustrated construction, the lens 314 is constructed to optically capture the front desired zone 330a and the peripheral desired zones 330b, 330c. The lens maps the zones 330a, 330b, 330c to capture objects directly in front of the camera 310 and objects at relatively wide angles (including objects positioned slightly behind the camera 310). More specifically, the lens 314 maps and arrange the pixels within the desired zones 330a, 330b, 330c so each desired zone 330a, 330b, 330c has a desired pixel distribution consistent with what is described with regard to FIGS. 3-5. The lens 314 expands each captured zone 330a, 330b, 330c and, consequently, the pixels that are positioned within each captured zone 330a, 330b, 330c. The lens 314 maps the expanded captured zones 330a, 330b, 330c on the pixelated area of the camera sensor 318 to produce the adjusted image 324 that represents a slightly distorted and refocused view of the captured zones 330a, 330b, 330c. As a result, objects in front of the camera 310 and objects at relatively wide locations to the left and right of the camera in each of the captured zones 330a, 330b, 330c appear the same size or approximately the same size and with uniform clarity. In some constructions, a processor 320 may transmit the adjusted image 324 to a display for use by personnel assigned to monitor the desired zone 330.

In one non-limiting example, the camera 310 is mounted to a front part of a vehicle (e.g., a police car) to monitor the zone 330a directly in front of the vehicle and peripheral zones 330b, 330c to the sides of the zone 330a. The peripheral zones 330b, 330c may include objects that are at relatively wide angles both relatively close to the camera 310 (e.g., in the vehicle's blind spots), as well as objects that are objects relatively far away from the camera 310. The lens 314 optically captures the zones 330a, 330b, 330c and expands the zones 330a, 330b, 330c to define the adjusted image 324 that matches or fills the aspect ratio of the camera sensor 318. As a result, the adjusted image 324 allows the camera 310 to monitor objects in the peripheral zones 330b, 330c with the same or substantially the same clarity as the zone 330a. The adjusted image 324 can be stored and/or transmitted to a display to allow a user to monitor the adjusted image 324 of the captured desired zones 330a, 330b, 330c. Additionally or alternatively, imaging software, such as OCR or machine vision, may be used to analyze the adjusted image 324 to detect objects such as license plates, people, etc., in the captured desired zones 330a, 330b, 330c of the adjusted image 324.

The embodiment(s) described above and illustrated in the figures are presented by way of example only and are not intended as a limitation upon the concepts and principles of the present disclosure. As such, it will be appreciated that variations and modifications to the elements and their configurations and/or arrangement exist within the scope of one or more independent aspects as described.

What is claimed is:

1. A system for capturing an image comprising:
a camera positioned relative to an area;
a camera sensor having an X-Y plane and an aspect ratio defined by a quantity of pixels in the X-Y plane; and
a lens constructed with a profile to optically capture a desired zone of the area,
wherein the lens remaps pixels associated with the area outside the desired zone to within the desired zone to form a desired pixel distribution within a captured image of the desired zone.

2. The system of claim 1, wherein the lens increases a density of the pixels in the desired zone.

3. The system of claim 1, wherein:
the lens further comprises an aperture that controls the amount of light that enters the lens, and
the lens is configured to adjust a focal point of each pixel in the desired zone without changing the aperture size of the lens.

4. The system of claim 1, further comprising a processor configured to process the pixels to store and generate an adjusted image.

5. The system of claim 1, wherein the lens remaps the pixels to increase a pixel density associated with a far region of the area.

6. The system of claim 1, wherein the desired zone comprises at least one path, and the lens remaps pixels associated with a portion of the area not including the at least one path to the desired zone.

7. The system of claim 1, wherein the desired zone comprises an intersection of paths, and the lens remaps pixels associated with a portion of the area not including the intersection of paths to the desired zone.

8. The system of claim 1, wherein the desired zone comprises a surface, and the lens remaps pixels associated with a portion of the area not including the surface to the desired zone.

9. The system of claim 1, wherein the desired zone comprises a roadway, and the lens remaps pixels not associated with the roadway to increase a pixel density associated with a far region of the roadway as compared to a near region of the roadway.

10. The system of claim 1, wherein the desired region comprises a forward zone, and a peripheral zone, and the lens remaps pixels associated with a portion of the area outside the forward zone and the peripheral zone to the desired zone.

11. A method for capturing an image comprising:
positioning a camera relative to an area, wherein the camera comprises a camera sensor having an X-Y plane and an aspect ratio defined by a quantity of pixels in the X-Y plane, and a lens constructed with a profile to optically capture a desired zone of the area; and
capturing an image using the camera sensor, wherein the lens remaps pixels associated with the area outside the desired zone to within the desired zone to form a desired pixel distribution within the captured image of the desired zone.

12. The method of claim 11, wherein the lens increases a density of the pixels in the desired zone.

13. The method of claim 11, wherein the lens further comprises an aperture that controls the amount of light that enters the lens, and the lens is configured to adjust a focal point of each pixel in the desired zone without changing the aperture size of the lens.

14. The method of claim 11, further comprising processing the pixels in a processor of the camera to store and generate an adjusted image from the captured image.

15. The method of claim 11, wherein the lens remaps the pixels to increase a pixel density associated with a far region of the area.

16. The method of claim 11, wherein the desired zone comprises at least one path, and the lens remaps pixels associated with a portion of the area not including the at least one path to the desired zone.

17. The method of claim 11, wherein the desired zone comprises an intersection of paths, and the lens remaps pixels associated with a portion of the area not including the intersection of paths to the desired zone.

18. The method of claim 11, wherein the desired zone comprises a surface, and the lens remaps pixels associated with a portion of the area not including the surface to the desired zone.

19. The method of claim 11, wherein the desired zone comprises a roadway, and the lens remaps pixels not associated with the roadway to increase a pixel density associated with a far region of the roadway as compared to a near region of the roadway.

20. The method of claim 11, wherein the desired region comprises a forward zone, and a peripheral zone, and the lens remaps pixels associated with a portion of the area outside the forward zone and the peripheral zone to the desired zone.
